(19) United States
(12) Patent Application Publication
(10) Pub. No.: US 2010/0124064 A1
(43) Pub. Date: May 20, 2010

(54) LIGHTING DEVICE INCLUDING TRANSLUCENT COVER FOR DIFFUSING LIGHT FROM LIGHT SOURCE

(75) Inventors: Kozo Ogawa, Yokosuka-shi (JP); Akimichi Takahashi, Yokohama-shi (JP); Erika Takenaka, Yokohama-shi (JP); Hiroaki Watanabe, Odawara-shi (JP); Keiichi Shimizu, Yokohama-shi (JP); Shinji Nogi, Tokyo (JP); Shinichi Kumashiro, Yokohama-shi (JP)

Correspondence Address: DLA PIPER LLP US, P. O. BOX 2758, RESTON, VA, 20195, US

(73) Assignees: TOSHIBA LIGHTING & TECHNOLOGY CORPORATION, Yokosuka-shi (JP); KABUSHIKI KAISHA TOSHIBA, Minato-ku (JP)

(21) Appl. No.: 12/619,701

(22) Filed: Nov. 17, 2009

(30) Foreign Application Priority Data
Nov. 18, 2008 (JP) 2008-294727
Dec. 1, 2008 (JP) 2008-306127

(51) Int. Cl. F21V 7/00

(52) U.S. Cl. 362/307

(57) ABSTRACT

A lighting device includes a light source configured to radiate light toward a floor from a ceiling, a reflecting mirror provided around the light source, and shading angle setting element configured to define a range in which the light from the light source is radiated by setting a shading angle with respect to the light radiated from the light source. The light source, the reflecting mirror and the shading angle setting element are covered by a translucent cover. The translucent cover has an in-line transmittance. An in-line transmittance of the translucent cover of a position corresponding to an optical axis of the light source and an in-line transmittance of the translucent cover of a position deviated from the optical axis are different from each other.

### CROSS-REFERENCE TO RELATED APPLICATIONS

This application is based upon and claims the benefit of priority from prior Japanese Patent Applications No. 2008-294727, filed Nov. 18, 2008; and No. 2008-306127, filed Dec. 1, 2008, the entire contents of both of which are incorporated herein by reference.

### BACKGROUND OF THE INVENTION

1. Field of the Invention

The present invention relates to lighting devices for radiating light toward a floor from a ceiling. More particularly, the present invention relates to a structure for sufficiently securing brightness while suppressing discomfort glare when a lighting device is viewed from below.

2. Description of the Related Art

In the field of lighting devices used for indoor general lighting, energy conservation has been pursued to achieve the goal of 10 W/m². In order to achieve energy conservation of lighting devices, it is necessary to improve luminous efficacy of a light source itself, and effectively take out light radiated from the light source as light for lighting purpose.

Light emitting diodes, for example, have higher efficiency and a longer lifespan than existing light sources, such as fluorescent lamps and incandescent lamps. The luminous efficacy of light emitting diodes is increasing year after year, and is predicted to reach 200 lm/W in the future. Recently, as light emitting diodes have become high-powered, lighting devices for general lighting purposes using light emitting diodes as light source have been proposed.

When light is radiated toward a floor from a ceiling through a lighting device employing light emitting diodes, luminance of the light emitting diodes needs to be increased in order to secure illuminance of a surface that receives light.

Light emitting diodes, however, are point sources of light having a light emission part smaller in shape than existing light sources, such as fluorescent lamps. Accordingly, a lighting device using high-luminance light emitting diodes easily causes a person discomfort glare when the person looks up the lighting device and visually identifies the light emitting part.

According to the lighting device disclosed in Japanese Patent KOKAI Publication No. 2007-214081, a semitransparent or opalescent translucent cover with light diffusion properties is provided below light emitting diodes so as to suppress glare.

Since a translucent cover prevents transmission of light, and will inevitably reduces luminaire efficiency. More specifically, when light emitting diodes are used as light source, a translucent cover of a darker color needs to be used, so as to suppress luminance of the light emitting diodes that can be seen through the translucent cover to the same level as that of the conventional fluorescent lamps. Thereby, luminaire efficiency of the lighting device drops to 20-40%, while glare is reduced. Furthermore, it is absolutely necessary for a lighting device for general house lighting purposes to thoroughly suppress glare when the lighting device is directly viewed.

In a lighting device disclosed in the above-described Japanese Patent KOKAI Publication, it is difficult to obtain sufficient brightness as base lighting while suppressing discomfort glare, and is susceptible to improvement in this respect.

### BRIEF SUMMARY OF THE INVENTION

An object of the present invention is to obtain a lighting device capable of obtaining sufficient brightness while suppressing deterioration in luminaire efficiency, and suppressing discomfort glare.

In order to achieve the above-described object, a lighting device according to the first aspect of the present invention comprises: a light source configured to radiate light toward a floor from a ceiling; a reflecting mirror provided around the light source so as to obtain desired luminous intensity distribution; a shading angle setting means configured to determine a range on which light from the light source is radiated by setting the shading angle with respect to the light radiated from the light source; and a translucent cover configured to cover the light source, the reflecting mirror and the shading angle setting means.

The translucent cover has an in-line transmittance, and an in-line transmittance of the translucent cover of a position corresponding to an optical axis of the light source and an in-line transmittance of the translucent cover of a position deviated from the optical axis are different from each other.

According to the first aspect of the present invention, light emitting diodes can be used as the light source. The reflecting mirrors should be arranged around the light source so as to surround the light source. The reflecting mirrors may be formed integrally with the main body of the lighting device or may be formed as a component separate from the main body. Furthermore, the reflecting mirror should desirably be spread toward the light radiation direction from the back side of the light source.

According to the first aspect of the present invention, the shading angle setting means should desirably set a desired shading angle within the range of 45 degrees with respect to the horizontal plane, for example, in order to perform general lighting preferable mainly for offices.

According to the first aspect of the present invention, the translucent cover is arranged below the light source so as to face the light source.

The translucent cover may be transparent, or have light diffusion properties. When the translucent cover has light diffusion properties, the in-line transmittance of the translucent cover should preferably set relatively high such that the inside of the lighting device is seen through.

In the first aspect of the present invention, the in-line transmittances different from each other mean that the translucent cover has at least two kinds of in-line transmittance. Further, the in-line transmittance varies according to the distance from the light source on a plane along the direction crossing the direction in which light is radiated the light source.

Examples of means for differentiating the in-line transmittance include particles having light diffusion or light reflection properties, and coatings containing such particles. The particles and the coatings may be applied, or deposited through vapor deposition on the outer surface or the inner surface of the translucent cover. Furthermore, it is also possible to provide the translucent cover itself with light diffusion properties with different in-line transmittances, without using the particles or coatings.

According to the second aspect of the present invention, the in-line transmittance of the translucent cover in the position corresponding to the optical axis of the light source is lower than the in-line transmittance of the translucent cover in the position deviated from the light source. In the second aspect, the position corresponding to the optical axis of the light source refers to the position right under the light source. According to the second aspect, discomfort glare is suppressed when a person looks up at the lighting device from a position right under the optical axis.

According to the third aspect of the present invention, the in-line transmittance of the translucent cover in the position corresponding to the optical axis of the light source is higher than the in-line transmittance of the translucent cover in the position deviated from the light source. According to the third aspect, discomfort glare is suppressed when a person looks up at the lighting device in a position apart from the position right under the optical axis.

In the fourth aspect of the present invention, an in-line transmittance of a translucent cover seamlessly varies between the position corresponding to the optical axis of the light source and the position deviated from the optical axis of the light source. According to the fourth aspect, unevenness in luminance of the translucent cover is suppressed from occurring.

According to the fifth aspect of the present invention, the shading angle setting means defines the direct radiation area on which light radiated from the light source is directly made incident on a translucent cover, and the peripheral area surrounding the direct radiation area. Furthermore, reflecting means, configured to let at least a portion of light that has been made incident on the direct radiation area from the light source reflect toward the reflecting mirror, is provided in the direct radiation area. According to the fifth aspect, lighting of the direct radiation area is performed by light directly radiated from the light source. The light reflected off the reflecting means is reflected off the reflecting mirror again, travels toward the translucent cover, and is supplied as light for mainly lighting the peripheral area.

In the sixth aspect of the present invention, the reflecting means has reflection properties such that light reflected toward the reflecting mirror reduces as the distance from the optical axis of the light source increases. According to the sixth aspect, the ratio of light that passes through the translucent cover increases as the distance from optical axis increases.

Thereby, brightness distribution in the direct radiation area is made balanced.

In the seventh aspect of the present invention, the reflecting mirror lets light reflected off the reflecting means of the translucent cover reflect toward the peripheral area of the translucent cover. According to the seventh aspect, the light reflected off the reflecting means passes through the peripheral area, and is radiated outside the lighting device. Accordingly, the light reflected off the reflecting means can be taken out as light for lighting, and decrease in luminaire efficiency is suppressed.

According to the eight aspect of the present invention, shading angle setting means includes a reflection pipe provided in the reflecting mirror.

The reflection pipe includes a first opening end that is open in the center of the reflecting mirror, and a second opening end located on the opposite side of the first opening end. A light source is arranged in the second opening end such that light is radiated toward the translucent cover from the first opening end, and a shading angle is set by the first opening end of the reflection pipe. According to the eight aspect, the inside of the reflection pipe is a light reflection surface. The light reflection surface may be either a mirror surface or a diffuse reflector. Furthermore, the cross-section of the reflection pipe may be rectangular well as circular.

In the ninth aspect of the present invention, a reflecting mirror includes an outer circumferential edge that protrudes toward a translucent cover more than the first opening end of a reflection pipe. The outer circumferential edge of the reflecting mirror sets a shading angle with respect to light radiated from the first opening end, such that the shading angle set by the outer circumferential edge of the reflecting mirror is smaller than the shading angle set by the first opening end of the reflection pipe. According to the ninth aspect, discomfort glare can be suppressed that occurs when a person looks up at the lighting device in a position apart from the position right under the optical axis.

According to the lighting device of the tenth aspect of the present invention, there is provided: a light source configured to radiate light toward a floor from a ceiling; a translucent cover provided below the light source so as to face the light source; a shading angle setting means configured to determine a direct radiation area on which light radiated from the light source is directly made incident on the translucent cover, by setting a shading angle for the light radiated from the light source; first reflecting means provided in the direct radiation area of the translucent cover, the first reflecting means configured to let at least a portion of the light that has been made incident on the direct radiation area; and second reflecting means configured to let the light reflected off the first reflecting means toward the area around the direct radiation area of the translucent cover.

The lighting device according to the tenth aspect of the present invention may be applied as a ceiling-mounted type device, a ceiling-embedded type device, or a luminous ceiling. Furthermore, one lighting system may be formed of a plurality of lighting devices by arranging the plurality of lighting devices having the configuration of the tenth aspect on the ceiling.

At the same time, a plurality of lighting modules may be prepared by combining a plurality of lighting devices into a unit and arranging the lighting modules on the ceiling.

In the tenth aspect, high-luminance light emitting diodes may be used as the light source. The size of the lighting device may be approximately 100 mm² when 4 W light emitting diodes are used, and may be approximately 50 mm² when 1 W light emitting diodes are used. According to the tenth aspect, the light source includes a plurality of light emitting diodes. The light emitting diodes are scattered, and radiate light from the ceiling toward the floor. The light emitting diodes may be configured such that the diodes themselves radiate white light, and if the diodes emit blue light or ultraviolet light, the blue or ultraviolet light may be wavelength-converted so as to radiate white light. Furthermore, the light emitting diodes may be configured to radiate white light by combining a plurality of light emitting diodes that emit different colors such that the relations of the three primary colors and the complementary colors are satisfied.

In the tenth aspect, the translucent cover is arranged below the light source so as to face the light source. The translucent cover may be independent with respect to each light source, or may be independent with respect to each lighting module that is a unit into which a plurality of light sources are combined. Furthermore, the translucent cover may be configured to be shared by a plurality of lighting modules. The translucent cover may be transparent or have light diffusion properties. When the translucent cover has light diffusion properties, the in-line transmittance of the translucent cover should desirably be set high so that the inside of the lighting device is seen through.

In the tenth aspect, the shading angle setting means should desirably set a desired shading angle within the range of 45 degrees with respect to the horizontal plane, for example, so as to perform general lighting preferable mainly for offices, for example. The shading angle setting means controls luminous intensity distribution so that illumination of the light receiving surface that receives light from a direct radiation area of the translucent cover is optimum for work in offices, for example. More specifically, the direct radiation area exists within a cut-off angle, which is expressed in by value obtained by deducting the shading angle from 90 degrees. Assuming that the shading angle is 45 degrees, for example, the cut-off angle is 45 degrees. Lighting of the inside of the cut-off angle is performed by the light that has directly been radiated mainly from the light source. When the cut-off angle is 45 degrees, light distributed at the light distribution angle equal to or less than 45 degrees mainly distributes to lighting of the office.

The first reflecting means lets at least a portion of light traveling from the light source toward the direct radiation area of the translucent cover reflect. Existence of the first reflecting means allows the luminance of the direct radiation area of the translucent cover to be reduced to a desired value. Thereby, when a person looks up at the translucent cover from the position right under the translucent cover, the light source cannot be directly viewed, and discomfort glare is reduced. The first reflecting means may be selected and adopted as appropriate from the known means as will be described below.

(i) A semipermeable reflecting film is stacked on the approximately entire surface of the direct radiation area. Existence of the semipermeable reflecting film allows a portion of light from the light source that has been made incident on the semipermeable reflecting film pass through the semipermeable reflecting film and the direct radiation area of the translucent cover, and the remaining light is reflected off the semipermeable reflecting film.

(ii) A reflecting film including a large number of dotted patterns are stacked on the direct radiation area. The dotted patterns are scattered keeping a distance from each other such that a gap exists between adjacent patterns. Accordingly, when light from the light source is made incident on the pattern, the light is reflected without passing through the reflecting film. When light from the light source is made incident on the gap between the patterns, the light passes through the reflecting film and the direct radiation area of the translucent cover.

(iii) A semipermeable reflecting film including a large number of dotted patterns is stacked on the direct radiation area.

(iv) A semipermeable reflecting film or a reflecting film including a plurality of dotted patterns is stacked on an inner surface of the translucent cover that faces the light source, an outer surface of the translucent cover that is exposed outside the lighting device, or the inside of the translucent cover. The semipermeable reflecting film and the reflecting film including a large number of dotted patterns may be formed of materials such as metal evaporated films and print films formed mainly of fine particles of metal oxides. Furthermore, the patterns may be formed by printing white resin, for example, on the inside or the outside of the translucent cover.

According to the tenth aspect, the light reflected off the second reflection means is made incident on the periphery of the direct radiation area of the translucent cover. Much of the light that has been made incident on the periphery of the direct radiation area passes through the translucent cover without causing reflections. That is, light traveling toward the periphery of the direct radiation area is effectively taken out as light for lighting, and decrease in luminaire efficiency can be suppressed.

The second reflecting means has a function of letting light reflected off the first reflecting means reflect toward the lower part. Accordingly, the second reflection means should preferably be configured to be preferable for effectively reflecting light, such that the uniformity ratio becomes high. When a reflection surface is adopted as the second light reflection means, the reflection surface should be configured as a quadric surface of revolution, such as a paraboloid, as well as a mirror surface. When the reflection surface is configured as a quadric surface of revolution, the axis of the quadric surface of revolution may be placed approximately parallel to the vertical line, or may be inclined at an acute angle in the direction away from the vertical line as the distance decreases toward the direction of the light source. Thereby, the amount of light radiated periphery of the direct radiation area increases, and the uniformity ratio of lighting periphery of the direct radiation area is increased.

In the eleventh aspect of the present invention, a shading angle setting means includes a reflection pipe.

The reflection pipe includes a first opening end that is open toward the direct radiation area of the translucent cover, and a second opening end positioned on the opposite side of the first opening end. A light source is arranged in the second opening end such that light is radiated from the first opening end toward the translucent cover, and the shading angle is set by the first opening end of the reflection pipe. According to the eleventh aspect, the inner surface of the reflection pipe is a light reflection surface. The light reflection surface may be a mirror surface or a diffuse reflector. Furthermore, the cross-section of the reflection pipe may be rectangular as well as circular.

In the twelfth aspect of the present invention, the second reflecting means sets a shading angle with respect to light radiated from the first opening end of the reflection pipe such that the shading angle set by the second reflection means is smaller than the shading angle set by the first opening end of the reflection pipe. According to the twelfth aspect, assuming that the shading angle set by the first opening end is 45 degrees, the shading angle set by the second reflection means may be set to 30 degrees. Thereby, discomfort glare is reduced that occurs when a person looks up at a lighting device from a position apart from the light source.

In the thirteenth aspect of the present invention, the first reflecting means includes reflection properties such that light reflected toward the second reflecting means decreases as the distance from the optical axis of the light source increases. According to the thirteenth aspect, the ratio of light that passes through the translucent cover increases as the distance from the optical axis increases. Thereby, brightness distribution in the direct radiation area is made balanced.

According to the lighting device of the present invention, sufficient lighting can be obtained as base lighting while suppressing decrease in luminaire efficiency, and suppressing discomfort glare.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a lighting device according to a first embodiment of the present invention;

FIG. 2 is a front view of the lighting device according to the first embodiment of the present invention;

FIG. 3 is a cross-sectional view of the lighting device according to the first embodiment of the present invention;

FIG. 4 is a cross-sectional view of the lighting device illustrating positional relationship between a translucent cover including a plurality of reflecting layers and a plurality of light emitting diodes, according to the first embodiment of the present invention;

FIG. 5 is a characteristic diagram illustrating luminous intensity distribution of the lighting device according to the first embodiment of the present invention;

FIG. 6 is a cross-sectional view of a lighting device according to a second embodiment of the present invention;

FIG. 7 is a cross-sectional view of a lighting device according to a third embodiment of the present invention;

FIG. 8 illustrates relationship between a light of sight and a cut-off angle when a person looks up the lighting device, according to the third embodiment of present invention;

FIG. 9 is a cross-sectional view of a lighting device according to a fourth embodiment of the present invention;

FIG. 10 is a cross-sectional view of a lighting device according to a fifth embodiment of the present invention;

FIG. 11 is a plan view of the lighting device according to the fifth embodiment of present invention; and

FIG. 12 is a cross-sectional view illustrating light that passes a translucent cover and light that reflects off a semipermeable reflecting film, according to the fifth embodiment of present invention.

### DETAILED DESCRIPTION OF THE INVENTION

Hereinafter, a first embodiment of the present invention will be described with reference to FIG. 1 to FIG. 5.

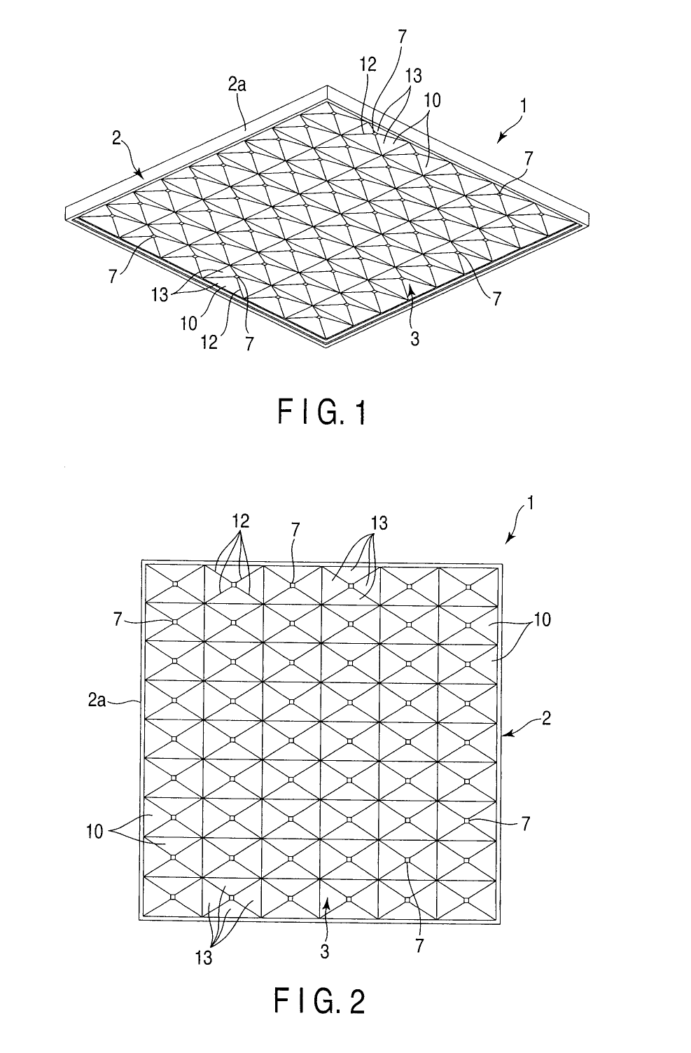

FIG. 1 and FIG. 2 disclose a lighting device 1 for indoor general lighting, for example, directly mounted to a ceiling. The lighting device 1 includes a device body 2, a reflector assembly 3, and a translucent cover 4. As shown in FIGS. 1-3, the device body 2 is directly mounted to the ceiling. The device body 2 is a flat rectangular solid, and takes the form of a square when viewed from below. The device body 2 includes a rectangular frame 2a and a top panel 2b covering an upper end of the frame 2a. The top panel 2b is fixed to the frame 2a via a plurality of screws 5 (only one of which is shown).

A rectangular circuit board 6 is contained in the device body 2. The circuit board 6 is mounted in the device body 2 via the screws 5, and is arranged horizontally so as to become parallel with the ceiling.

A lower surface of the circuit board 6 is a flat mount surface 6a. A plurality of light emitting diodes 7, which are mounted on the mount surface 6a of the circuit board 6. The light emitting diodes 7 are an example of light source, and are arranged in a matrix on the mount surface 6a.

According to the present embodiment, each of the light emitting diodes 7 includes a semiconductor light emitting element that emits blue light with the wavelength of 460 nm, for example, and a sealing member that molds the semiconductor light emitting element. The sealing member is formed of a transparent silicone resin, which is an example of translucency materials.

Yellow phosphor particles, for example, are mixed into the sealing member. The blue light emitted by the semiconductor light emitting element is made incident on the transparent sealing member. A portion of the blue light made incident on the sealing member is absorbed by the yellow phosphor particles. The remaining blue light passes through the sealing member without hitting the phosphor particles. The phosphor particles that have absorbed the blue light emit yellow light through wavelength conversion. Thereby, the yellow light and the blue light are mixed into white light, and the white light is radiated from the light emitting diode 7. Furthermore, the light emitting diode 7 includes an optical axis O1 extending in the radiation direction of light. The optical axis O1 passes through the center of light emitting diode 7 and extends in the vertical direction.

The reflector assembly 3 is supported by the frame 2a of the device body 2. The reflector assembly 3 includes a plurality of reflecting mirrors 10 corresponding to the light emitting diodes 7. The reflecting mirrors 10 are arranged systematically below the circuit board 6. Each of the reflecting mirrors 10 has a concave shape toward the circuit board 6. An opening 11 that exposes the light emitting diode 7 is formed in the central part of each of the reflecting mirrors 10.

As shown in FIGS. 1 and 2, each of the reflecting mirrors 10 includes four light reflection surfaces 13 that are divided by four ridgelines 12. The four light reflection surfaces 13 are arranged so as to surround one light emitting diode 7, and are inclined upward as the distance to the light emitting diodes 7 decreases. Accordingly, the light reflection surfaces 13 of the reflecting mirrors 10 are spread in shape from the back of the light emitting diode 7 toward the radiation direction of light. Thus, the reflecting mirrors 10 are configured such that desired luminous intensity distribution is obtained by letting the light emitted by the light emitting diodes 7 reflect downward.

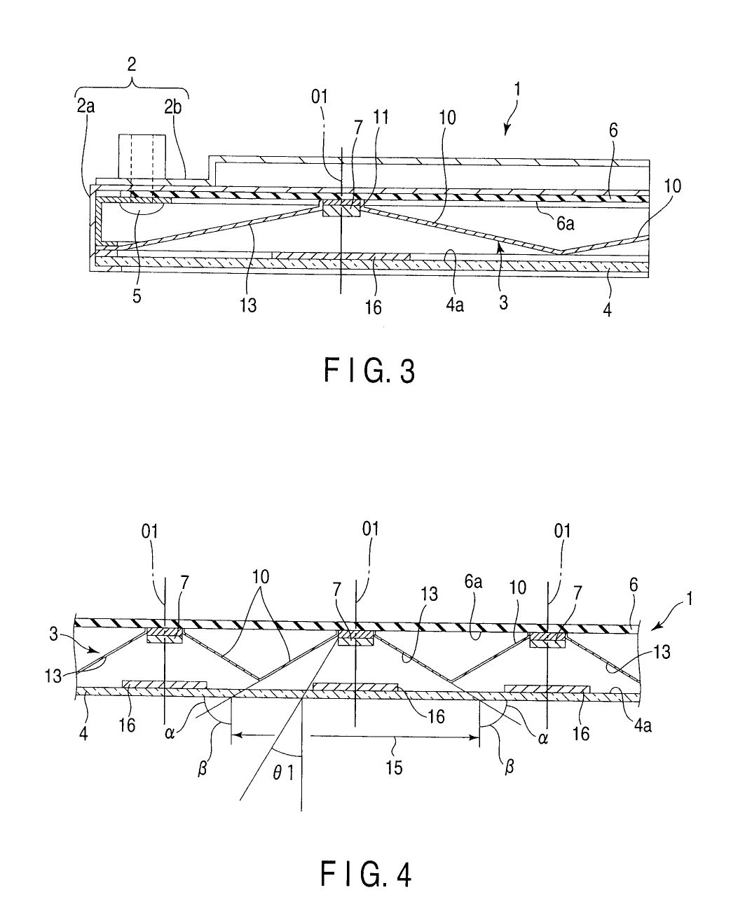

As shown in FIGS. 3 and 4, an outer circumferential edge of the light reflection surfaces 13 of the reflecting mirrors 10 protrudes downward more than the light emitting diode 7. In the outer circumferential edge of the light reflection surface 13, a shading angle α is set such that a person cannot directly look at the light emitting diodes 7 when the person looks up the light emitting diodes 7 at a position deviated from the optical axis O1. Accordingly, the outer circumferential edge of the light reflection surface 13 of each of the reflecting mirrors 10 also functions as means for setting the shading angle.

The translucent cover 4 is formed of a silicone-resin-based translucent material, for example. The translucent cover 4 is a rectangular plate, and is embedded in the frame 2a of the device body 2. The translucent cover 4 covers the reflector assembly 3 and the light emitting diodes 7 from below the device body 2.

As shown in FIG. 4, by setting the shading angle α in the outer circumferential edge of the light reflection surface 13, a direct radiation area 15 is defined, on which light radiated from the light emitting diode 7 is directly made incident, on the translucent cover 4. The direct radiation area 15 is an area defined by a cut-off angle β obtained by deducting the shading angle α from 90 degrees, and is located right under the light emitting diode 7. The optical axis O1 of the light emitting diode 7 crosses the direct radiation, area 15 at the center of the direct radiation area 15.

The translucent cover 4 includes an inner surface 4a facing the reflector assembly 3 and the light emitting diodes 7. A plurality of reflecting layers 16 are stacked on the inner surface 4a of the translucent cover 4. The reflecting layer 16 is located in the central part of the direct radiation area 15 so as to face the light emitting diode 7. Therefore, the reflecting layers 16 are arranged systematically keeping a distance from each other, so as to correspond to the light emitting diodes 7.

The reflecting layers 16, which are an example of reflecting means, are formed by applying a white coating to the inner surface 4a of the translucent cover 4, or depositing a material having light diffusion and reflection properties on the inner surface 4a of the translucent cover 4 through vapor deposition. The reflecting layer 16 has a lower light transmission rate and a higher degree of light diffusion than the translucent cover 4. Therefore, in-line transmittance of the translucent cover 4 varies in the translucent cover 4, between the part in which the reflecting layer 16 is stacked and the position deviated from the reflecting layer 16.

In other words, the translucent cover 4 includes two kinds of in-line transmittance. In the translucent cover 4 of the present embodiment, in-line transmittance of the position corresponding to the optical axis O1 of the light emitting diode 7 is lower than in-line transmittance of the position deviated from the optical axis O1.

When the light emitting diodes 7 of the lighting device 1 according to the first embodiment are turned on, the following general lighting will be performed as will be described below. White light emitted by the light emitting diodes 7 is radiated toward a floor from the direction of the ceiling. The light radiated along the optical axis O1 from the light emitting diodes 7 reaches the reflecting layers 16. A portion of the light that has reached the reflecting layers 16 is reflected off the reflecting layers 16 and travels to the reflecting mirrors 10, and the remaining light passes through the reflecting layers 16 and the translucent cover 4, and is radiated toward below the lighting device 1.

Right under the light emitting diodes 7, a portion of light radiated from the light emitting diodes 7 is shielded by the reflecting layers 16. This reduces luminance of the areas of the translucent cover 4 corresponding to the reflecting layers 16, and reduces discomfort glare that is caused when a person looks up the lighting device 1 from below.

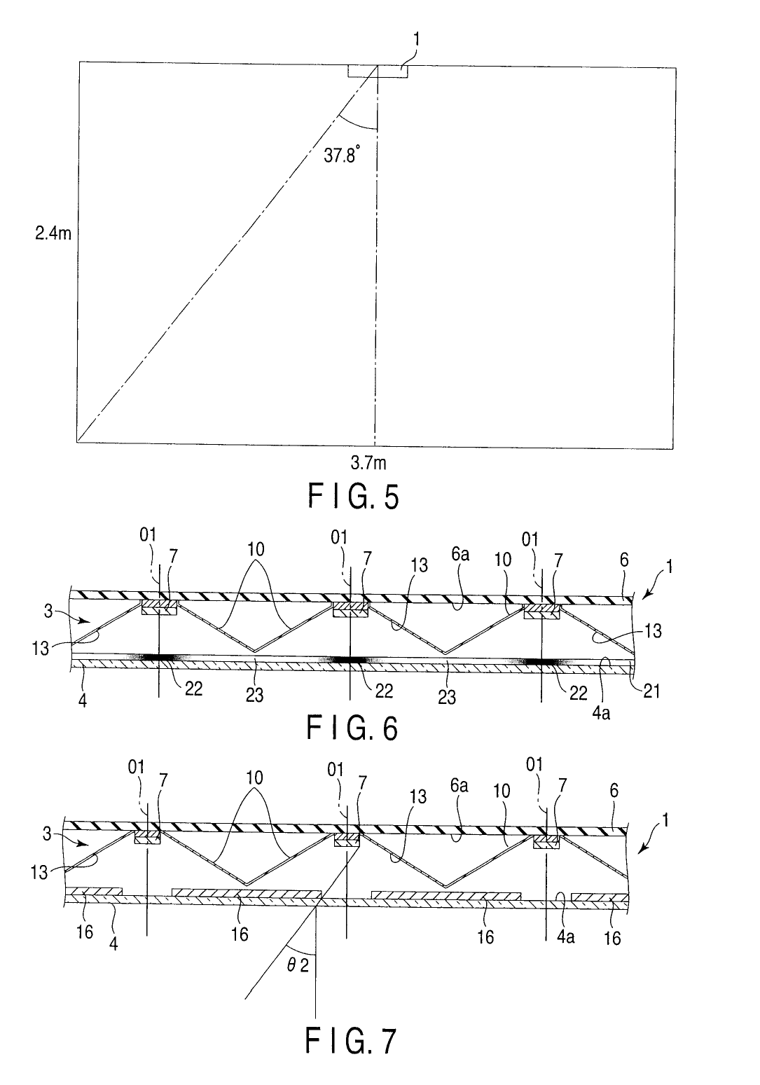

Furthermore, as shown in FIG. 4. the reflecting layers 16 are greater in area than the light emitting diodes 7. Accordingly, luminance of the translucent cover 4 is held down when a person looks up the lighting device 1 in the range of angle θ that is defined by the vertical line and the radiation direction of light radiated obliquely downward from the light emitting diodes 7 through the outer circumferential edges of the reflecting layers 16. More specifically, as shown in FIG. 5, it is known that the main living range of a resident in an eight-tatami room, for example, is within 37.8 degrees with respect to the vertical line that passes the center of the lighting device 1. Therefore, when an eight-mat room is lighted, discomfort glare is reduced by arranging the reflecting layers 16 such that the angle θ1 in FIG. 4 is 37.8 degrees, as long as the lighting device 1 is looked from below in the above-described living range.

The reflecting layers 16 are systematically arranged keeping a distance from each other, so as to correspond to the positions of the light emitting diodes 7. Accordingly, light that travels toward the areas between the reflecting layers 16 from the light emitting diodes 7 passes through the translucent cover 4 without being interrupted by the reflecting layers 16. In addition, the light reflected off the reflecting layers 16 is controlled with respect to luminous intensity distribution by being reflected off the light reflection surfaces 13 of the reflecting mirrors 10. Thereby, the light radiated from the light emitting diodes 7 is effectively taken out without waste outside the lighting device 1, and luminaire efficiency is increased. Furthermore, since light of the light emitting diodes 7 is led to a position in the translucent cover 4 that is deviated from the reflecting layers 16, luminance distribution of the translucent cover 4 is made balanced.

FIG. 6 discloses a second embodiment of the present invention. The second embodiment is different from the first embodiment in configuration of the reflecting layer 21 stacked on the inner surface 4a of the translucent cover 4. Besides the reflecting layer 21, the configuration of the lighting device 1 is same as that of the first embodiment. Accordingly, the configurations same as those of the first embodiment will be denoted by the same reference numerals, and detailed descriptions of such configurations will be omitted.

According to the second embodiment, the reflecting layer 21 is stacked on the entire surface of the inner surface 4a of the translucent cover 4. The reflecting layer 21 includes a plurality of first areas 22 located right under the light emitting diodes 7 and a plurality of second areas 23 deviated from the light emitting diodes 7. The first area 22 has a lower light transmission rate and higher light diffusion properties than the second area 23. Furthermore, the light transmission rate of the first area 22 varies such that the light transmission rate of the central part crossing the optical axis O1 of the light emitting diode 7 is the lowest and the light transmission rate continuously increases as the distance from the central part of the first area 22 increases.

Accordingly, in the translucent cover 4 of the second embodiment, the in-line transmittance of the part corresponding to the first area 22 of the reflecting layer 21 is lower than the in-line transmittance of the part corresponding to the second area 23, and the in-line transmittance continuously varies depending on the position of the light emitting diode 7.

In order to vary the in-line transmittance of the translucent cover 4, the thickness of the white coating forming the reflecting layer 21 may be changed, or the area where the coating is applied may be changed. Furthermore, by changing the size of the material having light diffusion and reflection properties, the in-line transmittance of the translucent cover 4 may be changed.

According to the second embodiment, the in-line transmittance of the translucent cover 4 varies depending on the position of the light emitting diodes 7. Accordingly, when light from the light emitting diodes 7 is made incident on the translucent cover 4, luminance distribution of the translucent cover 4 is made balanced.

FIG. 7 discloses a third embodiment of the present invention. In the third embodiment, a plurality of reflecting layers 16 are stacked on the inner surface 4a of the translucent cover 4 at positions deviated from the optical axis O1 of the light emitting diodes 7. Thereby, in the translucent cover 4 of the third embodiment, the in-line transmittance of the position corresponding to the optical axis O1 of the light emitting diode 7 is higher than the in-line transmittance of the position deviated from the optical axis O1.

In the third embodiment, light radiated along the optical axis O1 from the light emitting diodes 7 passes through the translucent cover 4 without being interrupted by the reflecting layers 16. Furthermore, a portion of light radiated toward a periphery of the optical axis O1 from the light emitting diode 7 travels toward the reflecting mirror 10, and the remaining light passes through the reflecting layers 16 and the translucent cover 4 and is radiated toward the area below the lighting device 1.

As shown in FIG. 7, in the range of angle θ2 defined by the vertical line and the radiation direction of light radiated obliquely downward from the light emitting diodes 7 through the outer circumferential edges of the reflecting layers 16, light radiated from the light emitting diodes 7 is shielded by the reflecting layers 16. Thereby, luminance of the area of the translucent cover 4 corresponding to the reflecting layers 16 decreases.

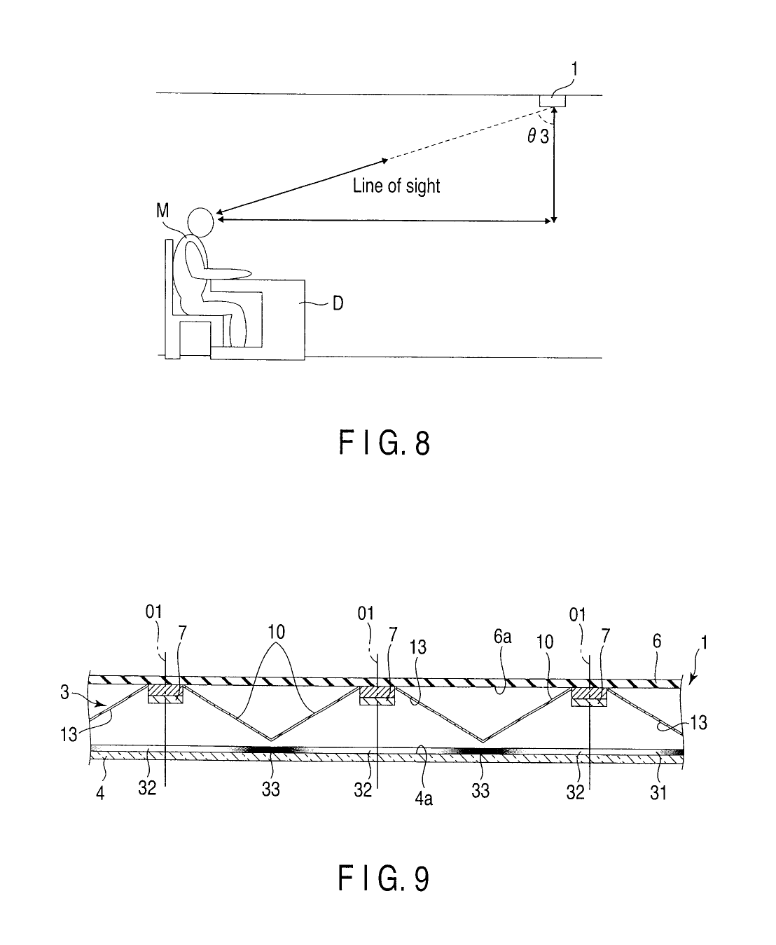

During desk work in an office and the like, a worker at his or her desk rarely looks up at the lighting device 1 right above. More specifically, as shown in FIG. 8, the worker M has more opportunities to look up the lighting device 1 from obliquely below. The focus of the experiment for evaluating discomfort glare of the lighting device 1 is the case where the angle θ3 defined by the line of sight of the worker M and the vertical line exceeds 30 degrees, when the worker M looked up the lighting device 1 from obliquely below.

Accordingly, when the reflecting layers 16 are provided in a position deviated from the optical axes O1 of the light emitting diodes 7, discomfort glare can be reduced by setting the reflecting layers 16 such that the angle O2 of FIG. 7 becomes 30 degrees.

FIG. 9 discloses a fourth embodiment of the present invention. In the fourth embodiment, the reflecting layer 31 is stacked on the entire surface of the inner surface 4a of the translucent cover 4.

The reflecting layer 31 includes a plurality of first areas 32 located right under the light emitting diodes 7 and a plurality of second areas 33 deviated from the light emitting diodes 7. The first areas 32 have a higher light transmission rate, and have lower light diffusion properties than the second areas 33.

Furthermore, the light transmittance of the first areas 32 varies such that the light transmittance of the central part crossing the optical axis O1 of the light emitting diodes 7 is the highest and the light transmittance seamlessly decreases as the distance from the central part of the first areas 32 including the optical axis O1 increases.

Accordingly, according to the translucent cover 4 of the fourth embodiment, the in-line transmittance of the parts corresponding to the first areas 32 of the reflecting layer 31 is higher than the in-line transmittance of the parts corresponding to the second areas 33, and the in-line transmittance seamlessly varies depending on the position of the light emitting diodes 7.

According to the fourth embodiment, when light from the light emitting diodes 7 is made incident on the translucent cover 4, luminance distribution of the translucent cover 4 is made balanced.

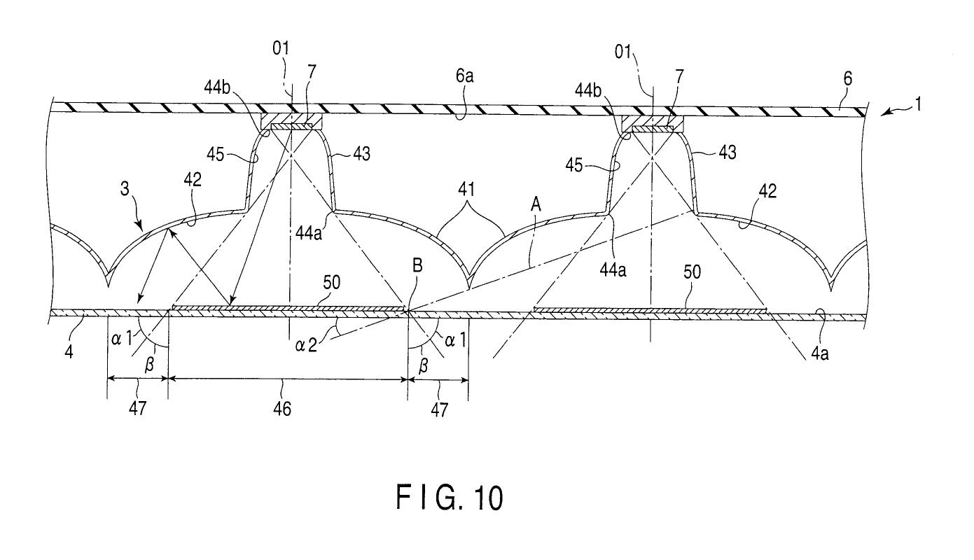

FIG. 10 to FIG. 12 discloses a fifth embodiment of the present invention. The fifth embodiment is different from the first embodiment in shape of a plurality of reflecting mirrors 41 included in a reflector assembly 3. Besides the reflecting mirrors 41, the configuration of the lighting device 1 is same as that of the first embodiment. Accordingly, configurations same as those of the first embodiment will be denoted by the same reference numerals in the fifth embodiment, and detailed descriptions of such configurations will be omitted.

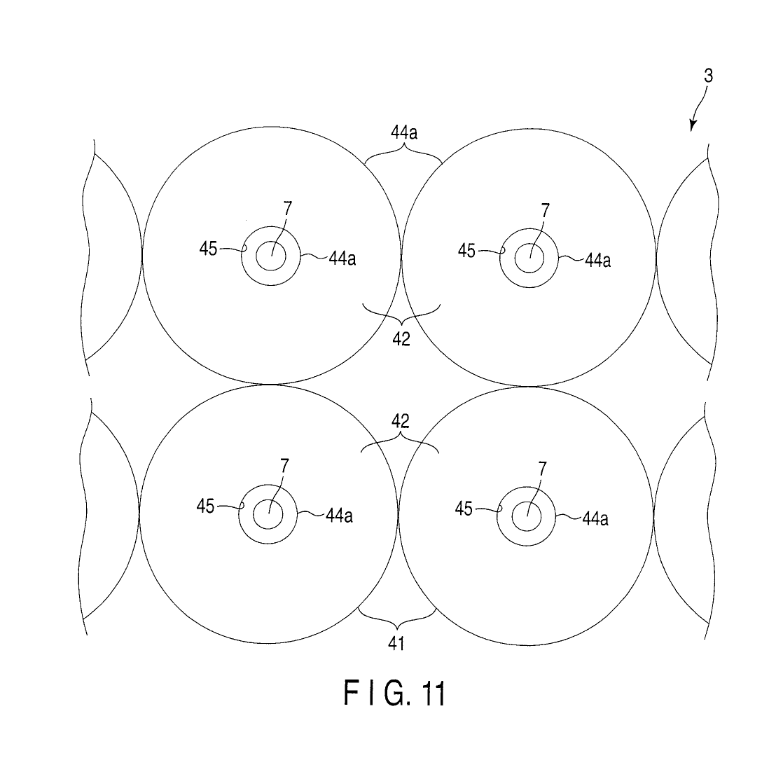

As shown in FIG. 10 and FIG. 11, a plurality of reflecting mirrors 41 are round-shaped when viewed from bottom, and are arranged systematically so as to correspond to the positions of the light emitting diodes 7. Furthermore, each of the reflecting mirrors 41 includes a light reflecting surface 42 facing the translucent cover 4. The light reflecting surface 42 is a quadric surface of revolution, such as a paraboloid, and is spread toward the translucent cover 4 from the circuit board 6 so as to obtain desired luminous intensity distribution.

Each of the reflecting mirrors 41 includes a cylindrical reflecting pipe 43. The reflecting pipe 43 is an example of a shading angle setting means, and is arranged coaxially with respect to the reflecting mirror 41. The reflecting pipe 43 includes a first opening end 44a and a second opening end 44b. The first opening end 44a is open in the central part of the light reflecting surface 42 so as to face the inner surface 4a of the translucent cover 4. The second opening end 44b is positioned on the opposite side of the first opening end 44a so as to face the mount surface 6a of the circuit board 6. The inner surface of the reflecting pipe 43 is a light reflecting surface 45.

The light reflecting surface 45 connects the second opening end 44b and the first opening end 44a.

The light emitting diode 7 mounted on the circuit board 6 is located in the second opening end 44b of the reflecting pipe 43. Light emitted by the light emitting diodes 7 is led into the reflecting pipe 43 from the second opening end 44b, and is radiated toward the translucent cover 4 from the first opening end 44a. The first opening end 44a of the reflecting pipe 43 is positioned between the light emitting diode 7 and the translucent cover 4. Accordingly, a first shading angle α1 is set in the first opening end 44a of the reflecting pipe 43 such that a person cannot directly view the light emitting diode 7 when the person looks up at the lighting device 1 from a position deviated from the optical axis O1. In the present embodiment, the first shading angle α1 is set to be equal to or more than 45 degrees.

As shown in FIG. 10, by setting the first shading angle α1 in the first opening end 44a of the reflecting pipe 43, a direct radiation area 46 and a peripheral area 47 are defined on the translucent cover 4.

The direct radiation area 46 is a area on which light radiated from the light emitting diode 7 is directly made incident. In other words, the direct radiation area 46 is an area defined by a cut-off angle β obtained by deducting the first shading angle α1 from 90 degrees, and is located right under the light emitting diode 7. The optical axis O1 of the light emitting diode 7 crosses the direct radiation area 46 in the central part of the direct radiation area 46.

The peripheral area 47 surrounds the direct radiation area 46. The peripheral area 47 faces the outer periphery of the light reflecting surface 42 of the reflecting mirror 41.

As shown in FIG. 10, a plurality of semipermeable reflecting films 50 are stacked on the inner surface 4a of the translucent cover 4. The semipermeable reflecting film 50 is an example of the first reflecting means, and is located in the direct radiation area 46 so as to face the light emitting diode 7. Accordingly, the semipermeable reflecting films 50 are arranged systematically keeping a distance from each other, so as to correspond to the light emitting diodes 7.

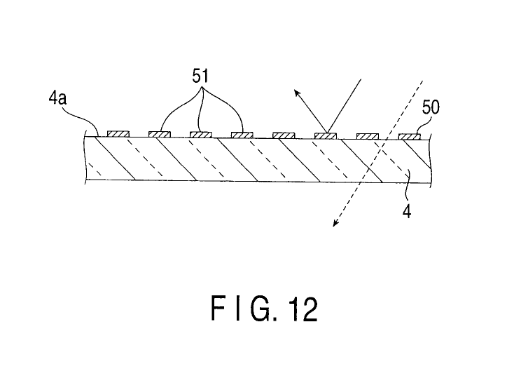

As shown in FIG. 12, the semipermeable reflecting film 50 includes a large number of dotted patterns 51 having light reflection properties. The pattern 51 are dense in the central part of the direct radiation area 46, through which the optical axis O1 of the light emitting diodes 7 passes, and become coarser as the distance from the optical axis O1 increases. In other words, the interval between the patterns 51 increases as the distance from the central part of the direct radiation area 46 increases toward the outer peripheral part.

When light from the light emitting diode 7 is made incident on the direct radiation area 46 of the translucent cover 4, a portion of the incident light hits the pattern 51, and is reflected toward the light reflecting surface 42 of the reflecting mirror 41, as denoted by the solid line in FIG. 12. Much of the remaining light that has been made incident on the direct radiation area 46 travels between the patterns 51, reaches and passes through the translucent cover 4, as denoted by the dashed arrow. The light traveling toward the light reflecting surface 42 is reflected off the light reflecting surface 42, and is led to the peripheral area 47 of the translucent cover 4. Thus, in the present embodiment, the reflecting mirrors 41 function as the second reflecting means.

In the central part of the direct radiation area 46, the patterns 51 of the semipermeable reflecting film 50 are denser than the outer peripheral part. Accordingly, the reflection performance of the semipermeable reflecting film 50 is high in the central part of the direct radiation area 46, and the reflection performance of the semipermeable reflecting film 50 decreases as the distance to the outer peripheral part of the direct radiation area 46 decreases. That is, the semipermeable reflecting film 50 has reflection properties such that light reflected toward the light reflecting surface 42 is reduced as the distance from the optical axis O1 of the light emitting diodes 7 increases.

Accordingly, luminance of the inside of the direct radiation area 46 is moderately reduced by the reflection effect of the semipermeable reflecting film 50. Thereby, luminance of the direct radiation area 46 seamlessly increases as the distance from the central part of the direct radiation area 46 to the outer peripheral part increases.

The semipermeable reflecting film 50 is provided only in the direct radiation area 46, and the semipermeable reflecting film 50 does not exist in the peripheral area 47 surrounding the direct radiation area 46. Thereby, the in-line transmittance of the direct radiation area 46 is lower than the in-line transmittance of the peripheral area 47.

As shown in FIG. 10, the outer circumferential edge of each of the reflecting mirrors 41 protrudes toward the translucent cover 4 from the first opening end 44a of the reflecting pipe 43. Accordingly, in the outer circumferential edge of the reflecting mirrors 41, a second shading angle α2 is set that hides the first opening end 44a of the reflecting pipe 43 and shields light radiated from the first opening end 44a, when a person looks up at the lighting device 1 from a position deviated from the optical axis O1. The second shading angle α2 is 30 degrees, for example, and is smaller than the first shading angle α1.

As shown in FIG. 10, the second shading angle α2 is determined by line segment A that connects the first opening end 44a of reflecting pipe 43 and the outer circumferential edge of the reflecting mirror 41. If light emitted from the first opening end 44a of the reflecting pipe 43 is below the line segment A, the light 43 travels toward the translucent cover 4. According to the present embodiment, the line segment A extending from a reflecting mirror 41 extends below the outer peripheral part of another adjacent reflecting mirror 41. Thereby, the intersection point B, at which the line segment A crosses the translucent cover 4, is positioned in a boundary between the direct radiation area 46, provided right under said another reflecting mirror 41, and the peripheral area 47.

According to the fifth embodiment, light emitted by the light emitting diode 7 is radiated toward the direct radiation area 46 of the translucent cover 4 from the first opening end 44a of the reflection pipe 41. A portion of light that has been made incident on the direct radiation area 46 hits the patterns 51 of the semipermeable reflecting film 50 and is reflected toward the light reflecting surface 42, as shown by the arrows in FIG. 10.

The light reflected off the semipermeable reflecting film 50 is reflected off the light reflecting surface 42 of the reflecting mirror 41 again, and travels toward the peripheral area 47 of the translucent cover 4. The light that travels toward the peripheral area 47 passes through the translucent cover 4, and is radiated toward the area below the lighting device 1.

In the lighting device 1 according to the fifth embodiment, the semipermeable reflecting film 50 is stacked on the direct radiation area 46 of the translucent cover 4, on which light radiated from the light emitting diode 7 is directly made incident. The existence of the semipermeable reflecting film 50 helps suppress luminance of the direct radiation area 46. Furthermore, since the second shading angle α2 is defined by the outer circumferential edge of the reflecting mirror 41, light radiated from the first opening edge 44a of the reflecting pipe 43 does not easily get into the eyes directly, even when a person looks up the lighting device 1 from a position at a distance. Thereby, discomfort glare is reduced that is caused when a person looks up the lighting device 1.

In addition, light reflected off the semipermeable reflecting film 50 is reflected off the light reflecting surface 42 of the reflecting mirror 41 toward translucent cover 4 again, and is made incident on the peripheral area 47 of the translucent cover 4. The light that has been made incident on the peripheral area 47 passes through the translucent cover 4 without causing reflections, and is radiated below the lighting device 1. Thereby, the light reflected off the semipermeable reflecting film 50 is effectively taken out as light for lighting purposes, and luminaire efficiency of the lighting device 1 is increased.

Furthermore, since reflection performance of the semipermeable reflecting film 50 is decreased as the distance from the central part of the direct radiation area 46 toward the outer peripheral part increases, the ratio of light that passes the translucent cover 4 increases in the outer peripheral part of the direct radiation area 46. Therefore, luminaire efficiency improves, and light is sufficiently taken out even in a position deviated from the optical axis O1.

According to the fifth embodiment, the intersection point B of the line segment A that defines the second shading angle α2 and the translucent cover 4 is positioned in a boundary between the direct radiation area 46 and the peripheral area 47 corresponding to the area right under adjacent reflecting mirror 41. Accordingly, by letting the light radiated from the first opening end 44a of the reflecting pipe 43 penetrate the peripheral area 47 corresponding to the adjacent reflecting mirror 41, light is taken out in the area below the lighting device 1. In other words, when the intersection point B is located in the direct radiation area 46 corresponding to the adjacent reflecting mirror 41, a portion of light emitted by the first opening end 44a of the reflecting pipe 43 is reflected off the semipermeable reflecting film 50 corresponding to the adjacent reflecting mirror 41. Thereby, loss of light occurs, and the ratio of light that passes through the peripheral area 47 decreases.

It is therefore desirable to set the second shading angle α2 such that the intersection point B of the line segment A is positioned within the peripheral area 47 corresponding to adjacent reflecting mirror 41.

Furthermore, in the fifth embodiment, since the semipermeable reflecting film 50 is provided in the direct radiation area 46, the light emitting diodes 7 are not directly recognized visually. In the case of the light emitting diodes 7 using yellow phosphors, the yellow tends to stand out when the lighting device is turned off. By providing the light emitting diodes 7 with a configuration that cannot be directly recognized visually, the color of the light emitting diodes 7 does not become noticeable when the lighting device is turned off.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A lighting device, comprising:
a light source configured to radiate light toward a floor from a ceiling;
a reflecting mirror provided around the light source so as to obtain desired luminous intensity distribution;
shading angle setting means configured to determine a range on which light from the light source is radiated, by setting a shading angle with respect to the light radiated from the light source; and
a translucent cover configured to cover the light source, the reflecting mirror, and the shading angle setting means, wherein the translucent cover has an in-line transmittance, and an in-line transmittance of the translucent cover of a position corresponding to an optical axis of the light source and an in-line transmittance of the translucent cover of a position deviated from the optical axis are different from each other.

2. The lighting device of claim 1, wherein the in-line transmittance of the translucent cover of the position corresponding to the optical axis of the light source is lower than the in-line transmittance of the translucent cover of the position deviated from the optical axis of the light source.

3. The lighting device of claim 1, wherein the in-line transmittance of the translucent cover of the position corresponding to the optical axis of the light source is higher than the in-line transmittance of the translucent cover of the position deviated from the optical axis of the light source.

4. The lighting device of claim 1, wherein the in-line transmittance of the translucent cover seamlessly varies between the position corresponding to the optical axis of the light source and the position deviated from the optical axis.

5. The lighting device of claim 1, wherein the shading angle setting means defines a direct radiation area on which light radiated from the light source is directly made incident and a peripheral area surrounding the direct radiation area on the translucent cover, reflecting means is provided in the direct radiation area and configured to let at least a portion of light that has been made incident on the direct radiation area from the light source reflect toward the reflecting mirror.

6. The lighting device of claim 5, wherein the reflecting means includes reflection properties such that light reflected toward the reflecting mirror reduces as a distance from the optical axis of the light source increases.

7. The lighting device of claim 6, wherein the reflecting mirror lets the light reflected off the reflecting means toward the peripheral area of the translucent cover.

8. The lighting device of claim 1, wherein the shading angle setting means includes a reflection pipe provided in the reflecting mirror, the reflection pipe includes a first opening end open in a central part of the reflecting mirror, and a second opening end located on the opposite side of the first opening end, the light source is arranged in the second opening end such that light is radiated toward the translucent cover from the first opening end, and the shading angle is set by the first opening end of the reflection pipe.

9. The lighting device of claim 8, wherein the reflecting mirror includes an outer circumferential edge protruding toward the translucent cover more than the first opening end of the reflection pipe, the outer circumferential edge sets a shading angle with respect to the light radiated from the first opening end, and the shading angle set by the outer circumferential edge is smaller than the shading angle set by the first opening end of the reflection pipe.

10. A lighting device, comprising:
a light source configured to radiate light toward a floor from a ceiling;
a translucent cover provided below the light source so as to face the light source;
a shading angle setting means configured to define a direct radiation area on which light radiated from the light source is directly made incident on the translucent cover, by setting a shading angle with respect to the light radiated from the light source;
first reflection means provided in the direct radiation area of the translucent cover, the first reflecting means letting at least a portion of the light that has been made incident on the direct radiation area reflect; and
second reflecting means configured to let the light reflected reflect off the first reflecting means toward an area around the direct radiation area of the translucent cover.

11. The lighting device of claim 10, wherein the shading angle setting means comprises a reflection pipe including a first opening end that opens toward the direct radiation area of the translucent cover, and a second opening located on the opposite side of the first opening end, the light source is arranged in the second opening end of the reflection pipe such that light is radiated toward the translucent cover from the first opening end, and the shading angle is set by the first opening end of the reflection pipe.

12. The lighting device of claim 11, wherein the second reflecting means sets a shading angle with respect to light radiated from the first opening end of the reflection pipe, and the shading angle set by the second reflecting means is smaller than the shading angle set by the first opening end of the reflection pipe.

13. The lighting device of claim 12, wherein the first reflecting means has reflection properties such that light reflected toward the second reflecting means reduces as a distance from the optical axis of the light source increases.
